(19) United States
(12) Patent Application Publication
(10) Pub. No.: US 2019/0241137 A1
(43) Pub. Date: Aug. 8, 2019

(54) Lifesaving apparatus for death and injury reduction in vehicle collision

(71) Applicant: Hongjun Pan, Lewisville, TX (US)

(72) Inventor: Hongjun Pan, Lewisville, TX (US)

(21) Appl. No.: 15/890,525

(22) Filed: Feb. 7, 2018

(51) Int. Cl. B60R 19/16

(52) U.S. Cl. CPC B60R 19/16

(57) ABSTRACT

A lifesaving apparatus is disclosed that contains a free rotation wheel which has a vertical rotation axis, multiple such lifesaving apparatuses are installed at the left, right and middle section of the front of the vehicle. When the vehicle collides with an object in non-perpendicular angle relative to the collision surface, the wheel will rotate and cause the vehicle to move along the collision surface until all energy is released, the lifesaving apparatus will substantially reduce the impact force on the vehicle and on the people in the vehicle, therefore, the deaths, injure and the damage of the vehicle will be dramatically reduced.

### THE BACKGROUND OF INVENTION

### Field of the Invention

The present invention relates generally to automobile vehicles, and, more particularly, to the lifesaving apparatus installed on the front of automobile vehicles to dramatically reduce the impact force in the accident collision.

### Description of the Prior Art

In modern society, the automobiles are the most commonly used for transportation in our daily life, collision accidents can happen at anywhere and anytime. Nearly 1.3 million people die in road crashes each year, on average 3,287 deaths a day. An additional 20-50 million are injured or disabled. Safety is the most important concern. There are huge number of prior arts in this aspect. Air bags are well known in the art now and become essential items in automobile vehicles. Some other patents are listed here as examples: the U.S. Pat. No. 3,794,136(A) and KR201000073922 (A) disclosed early alerting/detection systems for collision; the patent KR20120005214(A) disclosed an impact absorbing system installed along the road; the U.S. Pat. No. 9,067,617 B2 disclosed a safety device for orienting a vehicle front wheel transversally to the longitudinal direction following a collision. In the present invention a new lifesaving apparatus with high efficiency, low cost and easy installation is disclosed that can substantially reduce the impact force on people in the vehicle during the collisions and save lives and reduce injury.

### SUMMARY OF THE INVENTION

In present invention, a lifesaving apparatus contains a wheel that can rotate freely, multiple lifesaving apparatuses of present invention are mounted on the vehicle body frame at the front end located at the left and right corners and the middle section. When the front of a moving forward vehicle collides with an object such as a roadside crash barrier, another vehicle or other object non-perpendicularly to the collision surface, the wheel of the lifesaving apparatus will be the first part of the vehicle to contact the collision surface of the object and the wheel will be rolling along the collision surface of the object, therefore, the impact force of the collision will be substantially reduced, the deaths and injury will be dramatically reduced. The lifesaving apparatus of present invention is simple, low cost, high efficient and easy installation. The present invention can be better illustrated by the following drawings and detailed description.

### BRIEF DESCRIPTION OF DRAWINGS

FIG. 1 shows all the parts of the lifesaving apparatus of the present invention in assembly order.

FIG. 2 shows the lifesaving apparatus of the present invention mounted on the vehicle body frame.

FIG. 3 shows the multiple lifesaving apparatuses of present invention installed on the front of a passenger car.

FIG. 4 shows the multiple lifesaving apparatuses of present invention installed on the front of a pickup or light truck.

FIG. 5 shows the multiple lifesaving apparatuses of present invention installed on the front of a bus.

FIG. 6 illustrates how the lifesaving apparatus of present invention can reduce the impact force of collision on people in the vehicle.

FIG. 7 is close look of the collision when the lifesaving apparatus contacts the collision surface of the object.

### DESCRIPTION OF THE PREFERRED EMBODIMENT

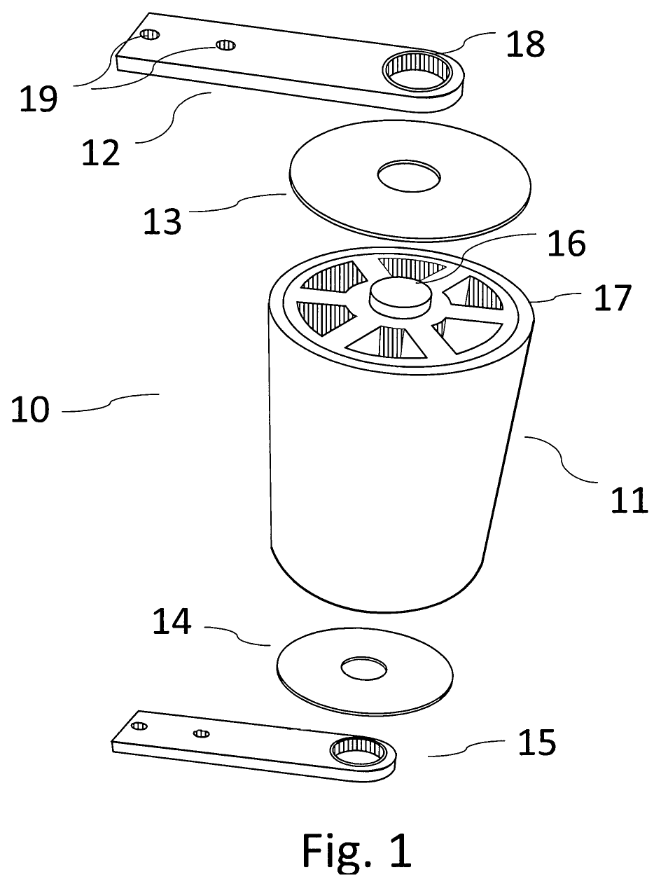

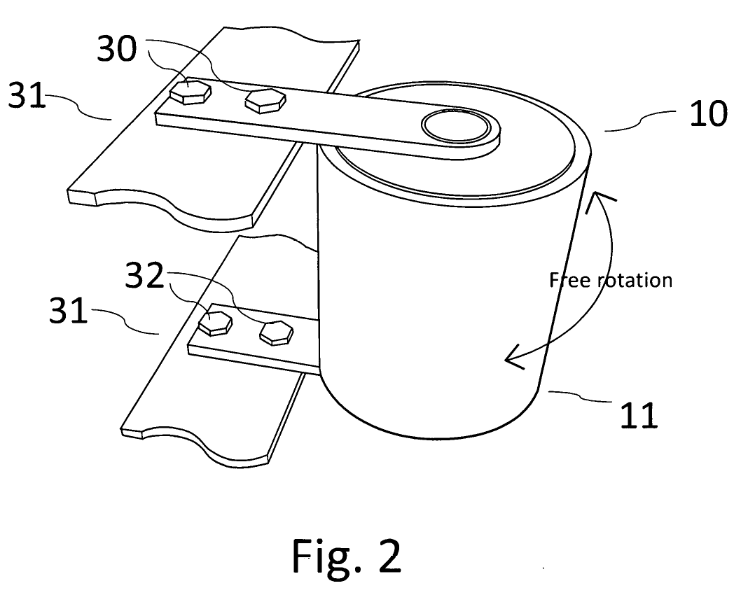

FIG. 1 shows the lifesaving apparatus 10. The said lifesaving apparatus 10 has a rim-type wheel 11, a top mounting bar 12, a top cap 13, a bottom cap 14 and a bottom mounting bar 15. The said rim-type wheel 11 has is a short mounting shaft 16 at top side and bottom (not shown) side, respectively, the said wheel 11 has rubber outer layer 17 for better performance. The said top mounting bar 12 has a bearing 18 at one end to receive the top shaft 16 of the wheel 11, there two mounting holes 19 at other end to receive two mounting bolts 30 (shown on FIG. 2) for installation on the vehicle frame 31. The rim type of the wheel 11 is to reduce the weight without compromising the performance, the internal hollow space of the wheel 11 is sealed by the caps 13 and 14 to prevent dust or other objects falling into it. The height of the wheel 11 varies based on the design of the vehicles. The bottom mounting bar 15 is identical to the top mounting bar 12.

FIG. 2 shows that the said lifesaving apparatus 10 is assembled and mounted on the vehicle body frame 31 by bolts 30 and 32. The said wheel 11 can rotate freely in this construction.

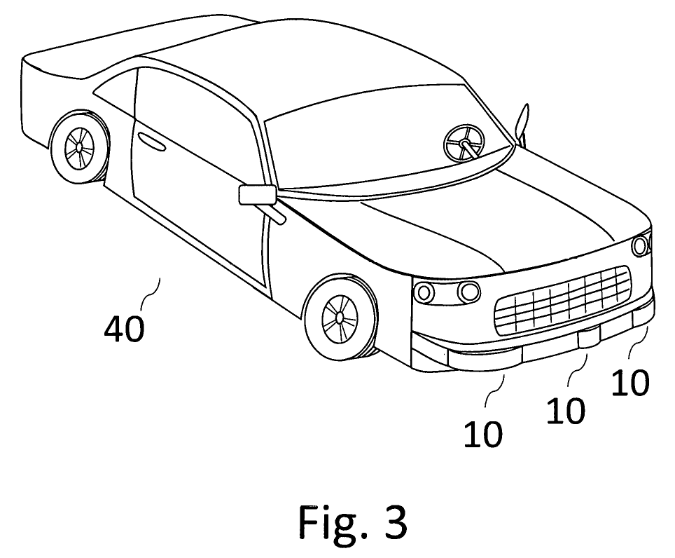

FIG. 3 shows that the multiple lifesaving apparatus 10 are installed at the front of a passenger car 40. The lifesaving apparatuses 10 are installed at the left and right corners of the conventional bumper location, respectively, and the third lifesaving apparatus 10 can be installed in the middle section as an option, the said lifesaving apparatuses 10 are the first contact parts during the collision when the vehicle moves forward and collides with other object at vehicle front.

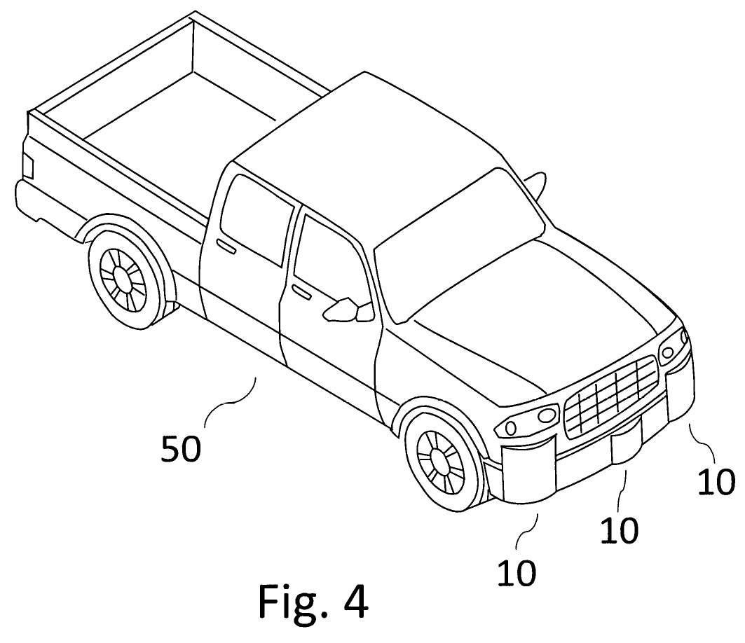

FIG. 4 shows that the multiple lifesaving apparatuses 10 are installed at the front of a pickup or light truck 50. The lifesaving apparatuses 10 are installed at the left and right front corners, respectively, and the third lifesaving apparatus 10 is installed in the middle section as an option. The lifesaving apparatuses 10 are the first contact parts during the collision when the vehicle moves forward and collides with other object at vehicle front.

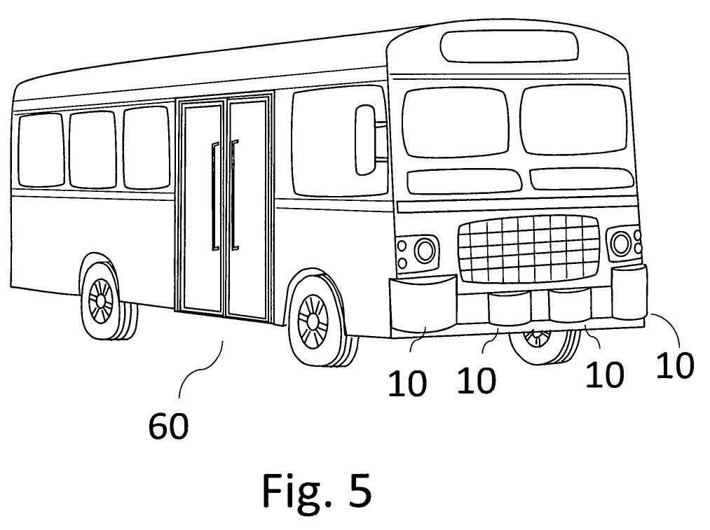

FIG. 5 shows that the multiple lifesaving apparatuses 10 are installed at the front end of a bus 60. The lifesaving apparatuses 10 are installed at the left and right front corners, respectively, and one or more lifesaving apparatuses 10 are installed in the middle section, which is highly suggested due to its wide front width, the apparatuses 10 are the first contact parts during the collision when the vehicle moves forward and collides with other object at vehicle front.

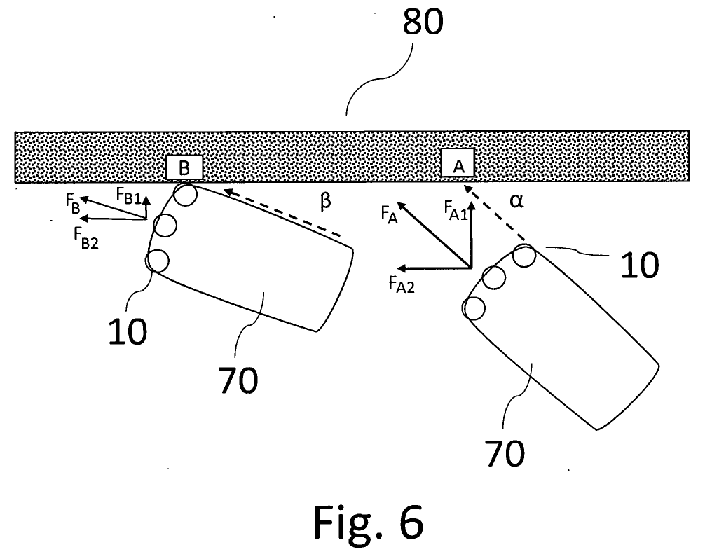

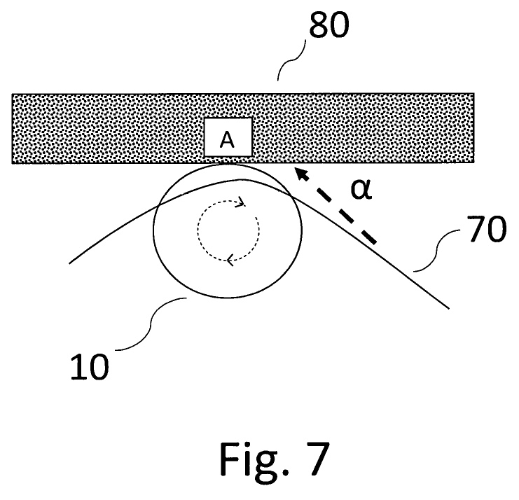

FIG. 6 shows how the said lifesaving apparatus 10 works. The vehicle 70 is on the way to collide with an object 80 which can be a roadside crash barrier, another vehicle or other object. Refer to this drawing. Multiple lifesaving apparatuses 10 are installed at the front of the vehicle 70, the vehicle 70 move forward in the direction of the dash line arrow with an angle α respective to the collision surface of the object 80, and collide at the point A, The total collision force carried by the vehicle 70 is F_{A}, the F_{A} can be decomposed into two components F_{A1} and F_{A2}, The F_{A1} is perpendicular to the collision surface and the F_{A2} is parallel to the collision surface. For a vehicle without the said lifesaving apparatus 10 installed, the total impact force F_{A} will act on the vehicle and all people in the vehicle instantly and cause personal injure and vehicle damage. For a vehicle 70 with the said lifesaving apparatus 10 installed, when the vehicle 70 contacts the collision surface at point A, the perpendicular force component F_{A1} is responsible for the injury and damage; and the parallel force component F_{A2} will cause the wheel of the said lifesaving apparatus 10 located at the right front corner rotating, therefore, the vehicle will rolling-glide along the collision surface as illustrated in the FIG. 7 for a close look. When the vehicle rolling-glides along the collision surface, it still has speed and carries moving energy, the whole body of the vehicle 70 may rotate towards a smaller angle β at point B, however, it will be much less harmful; this process is just like an airplane touch down landing. The Vehicle will continue rolling-gliding until all energy of the vehicle is released, as a result, the collision is much “smoother” or “softer”. The initial harmful impact force F_{A1} is a function of the collision angle α as the following equation:

F_{A1}=F_{A}×sin α

the F_{A1} is maximum when the vehicle collides perpendicularly to the collision surface where a is 90 degree; The F_{A1} is about 30% less than F_{A} when the vehicle collides to the collision surface with 45 degree angle, such 30% difference could mean life or death. Most of collisions are non-perpendicular, so it is highly expected that when the lifesaving apparatuses are installed in all vehicles around the world, millions of lives will be saved during the collisions in the future and personal injury and the damage of the vehicles by the collision will be substantially reduced. The lifesaving apparatus of the present invention is very simple, low cost and easy to install.

Whereas the present invention has been described in particular relation to the drawings attached hereto, it should be understood that other and further modifications based on the actual application and cosmetic design of vehicle front, apart from those shown or suggested herein, may be made within the spirit and scope of this invention.

What is claimed is:

1. A lifesaving apparatus installed at the front end of vehicles to reduce the impact force on vehicles and on the people in the vehicles.

2. The said lifesaving apparatus in claim 1 has a free rotation wheel and the wheel will freely rotate when the vehicle front collides with an object.

3. The rotation wheel of lifesaving apparatus in claims 1 and 2 may have a rubber outer layer.

4. Multiple of the said lifesaving apparatus in claims 1 and 2 are installed at the left and right front corners and the front middle section of the vehicle.
